(19) United States
(12) Patent Application Publication
(10) Pub. No.: US 2026/0117065 A1
(43) Pub. Date: Apr. 30, 2026

(54) INSULATING RESIN COMPOSITION AND ARTICLE MADE THEREFROM

(71) Applicant: ELITE ELECTRONIC MATERIAL (KUNSHAN) CO., LTD., Kunshan City (CN)

(72) Inventors: Wentao XUE, Kunshan City (CN); Rongtao WANG, Kunshan City (CN); Zhaopeng LUO, Kunshan City (CN); Yiqiang GE, Kunshan City (CN)

(73) Assignee: ELITE ELECTRONIC MATERIAL (KUNSHAN) CO., LTD., Kunshan City (CN)

(21) Appl. No.: 19/010,424

(22) Filed: Jan. 6, 2025

(30) Foreign Application Priority Data
Oct. 25, 2024 (CN) 202411505290.5

(51) Int. Cl. C08L 71/12; C08F 230/02; C08G 73/10

(52) U.S. Cl. CPC C08L 71/126; C08F 230/02; C08G 73/10; C08L 2201/02; C08L 2203/16; C08L 2203/20

(57) ABSTRACT

The present disclosure discloses an insulating resin composition, comprising: component (A): 100 parts by weight of an unsaturated carbon-carbon double bond-containing polyphenylene ether resin and/or a maleimide resin, and component (B): 10 to 65 parts by weight of a phosphorus-containing monomer represented by formula (1). In Formula (1), Rn is a C2 to C4 alkenyl-substituted phenyl group, and each of R₁₂ and R₁₃ is independently a C1 to C4 alkyl, a C2 to C4 alkenyl, a phenyl, a C1 to C4 alkyl-substituted phenyl, a C2 to C4 alkenyl-substituted phenyl, a biphenyl or a naphthyl. Besides, the present disclosure also discloses an article made from the insulating resin composition, including prepreg, resin film, metal foil-clad laminate or printed circuit board. The article has improvements in at least one properties including inner resin flow, edge stripe, flame resistance, peel strength, dissipation factor, and Z-axis percent of thermal expansion.

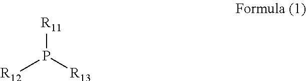

### CROSS-REFERENCE TO RELATED APPLICATIONS

This non-provisional application claims priority under 35 U.S.C. § 119(a) on Patent Application No(s). 202411505290.5 filed in China on Oct. 25, 2024, the entire contents of which are hereby incorporated by reference.

### BACKGROUND

### 1. Technical Field

The present disclosure relates to an insulating resin composition and an article made therefrom, particularly to an insulating resin composition that can be applied to a prepreg, a resin film, a metal foil-clad laminate and a printed circuit board, and an article made therefrom.

### 2. Related Art

Printed circuit boards (PCBs), which are fundamental electronic components, are widely used in various fields such as mobile phones, computers, mobile communication, data centers, automotive, industrial control, medical devices, and aerospace. The technical level and reliability of PCBs directly affect the performance and stability of electronic devices. With the development of technologies such as mobile communication and AI, the transmission rate and communication frequency of signals have significantly increased. Metal foil-clad laminates, which are the substrate material for PCBs, primarily provide functions such as interconnection, signal transmission, and insulation support for the PCBs. They have a significant impact on aspects such as signal transmission speed, energy loss, and characteristic impedance in circuits. The overall performance, quality, reliability, and stability of PCBs largely depend on the performance and quality of the metal foil-clad laminates.

Currently, advanced PCB packaging technologies face challenges in areas such as process capability, signal integrity, heat dissipation, and stress, requiring higher demands for the performance of metal foil-clad laminates. These demands include suitable resin flow, higher flame resistance and peel strength, lower dissipation factor and Z-axis percent of thermal expansion.

There is an urgent need in the field to develop insulating resin compositions and articles made therefrom with properties such as suitable resin flow, higher flame resistance and peel strength, lower dissipation factor and Z-axis percent of thermal expansion.

### SUMMARY

### Technical Problems to be Solved by the Present Disclosure

How to provide an insulating resin composition and an article made therefrom with at least one of properties including suitable inner resin flow, higher flame resistance and peel strength, lower dissipation factor and Z-axis percent of thermal expansion.

### Technical Solutions to the Technical Problems

The present disclosure is made in view of the above technical problems. The inventors have studied the individual and combined use of various unsaturated phosphorus-containing monomers in insulating resin compositions, particularly the individual and combined use of phosphorus-containing monomers with different numbers of unsaturated bonds in insulating resin compositions, thereby obtaining the present disclosure. The specific content thereof is described below.

The first aspect of the present disclosure is to provide an insulating resin composition, and the insulating resin composition includes:
(A): 100 parts by weight of an unsaturated carbon-carbon double bond-containing polyphenylene ether resin and/or a maleimide resin, and
(B): 10 to 65 parts by weight of a phosphorus-containing monomer represented by Formula (1),

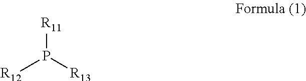

in Formula (1), Ru is a C2 to C4 alkenyl group-substituted phenyl group, and each of R₁₂ and R₁₃ is independently a C1 to C4 alkyl group, a C2 to C4 alkenyl group, a phenyl group, a C1 to C4 alkyl group-substituted phenyl group, a C2 to C4 alkenyl group-substituted phenyl group, a biphenyl group or a naphthyl group.

In one preferred embodiment, the phosphorus-containing monomer represented by Formula (1) includes one or more of compounds represented by Formula (1-1) to Formula (1-10),

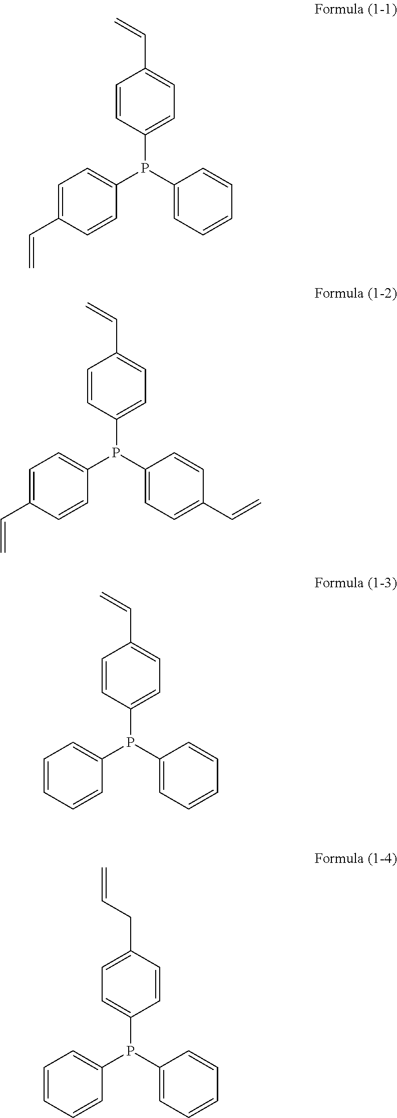 [SMILES: C=Cc1ccc(P(c2ccccc2)c2ccc(C=C)cc2)cc1 ; C=Cc1ccc(P(c2ccc(C=C)cc2)c2ccc(C=C)cc2)cc1 ; C=Cc1ccc(P(c2ccccc2)c2ccccc2)cc1 ; C=CCc1ccc(P(c2ccccc2)c2ccccc2)cc1]

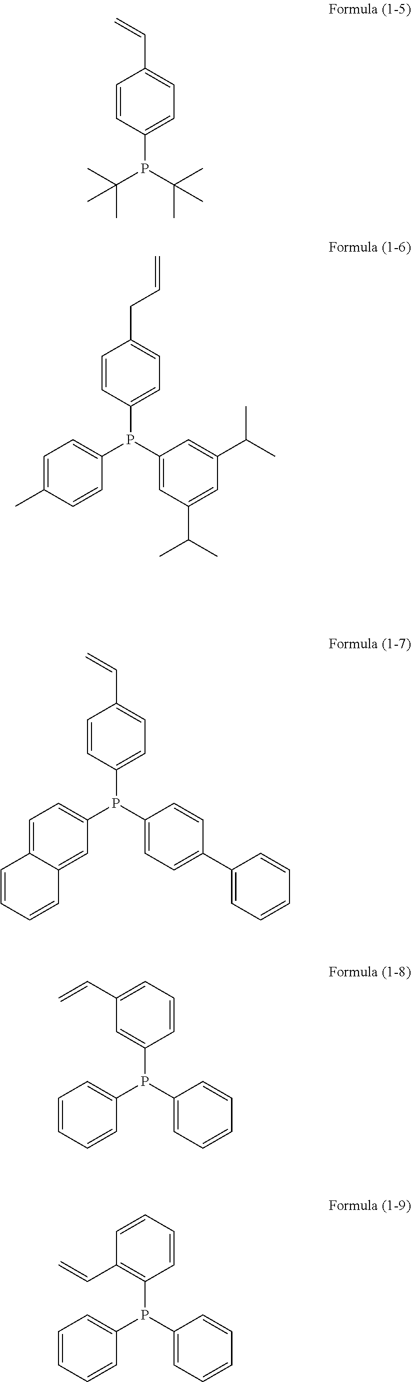

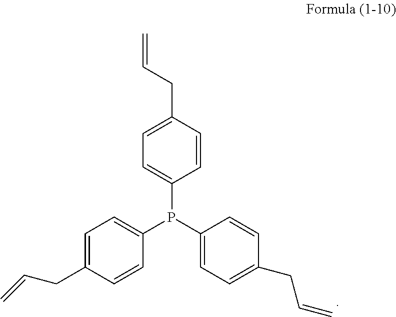 [SMILES: C=CCc1ccc(P(c2ccc(CC=C)cc2)c2ccc(CC=C)cc2)cc1]

In one preferred embodiment, the insulating resin composition does not include the phosphorus-containing monomer represented by Formula (1) with one C2 to C4 alkenyl group alone, and does not include the phosphorus-containing monomers represented by Formula (1) with at least three C2 to C4 alkenyl group alone.

In one preferred embodiment, the unsaturated carbon-carbon double bond-containing polyphenylene ether resin includes any one of a vinylbenzyl group-containing polyphenylene ether resin, a (meth)acryloyl group-containing polyphenylene ether resin, a vinyl group-containing polyphenylene ether resin, an allyl group-containing polyphenylene ether resin or a combination thereof.

In one preferred embodiment, the maleimide resin includes any one of a 4,4′-diphenylmethane bismaleimide, a polyphenylmethane maleimide, a bisphenol A diphenyl ether bismaleimide, a 3,3′-dimethyl-5,5′-diethyl-4,4′-diphenylmethane bismaleimide, a 3,3′-dimethyl-5,5′-dipropyl-4,4′-diphenylmethane bismaleimide, a m-phenylene bismaleimide, a 4-methyl-1,3-phenylene bismaleimide, a 1,6-bismaleimide-(2,2,4-trimethyl)hexane, an N-2,3-xylylmaleimide, an N-2,6-xylylmaleimide, an N-phenylmaleimide, a vinyl benzyl maleimide, an indane structure-containing maleimide, an isopropyl and meta-arylene structure-containing maleimide, a biphenyl structure-containing maleimide, a maleimide with aliphatic structure having 10 to 50 carbon atoms or a combination thereof.

In one preferred embodiment, the insulating resin composition further includes any one of a polyolefin, a benzoxazine resin, an epoxy resin, a polyester resin, a phenolic resin, an amine curing agent, a polyamide, a polyimide, a styrene maleic anhydride, a cyanate ester resin, a maleimide triazine resin or a combination thereof.

In one preferred embodiment, the insulating resin composition further includes any one of a flame retardant different from the phosphorus-containing monomer represented by Formula (1), a curing accelerator, a polymerization inhibitor, an inorganic filler, a solvent, a silane coupling agent, a surfactant, a coloring agent, a toughening agent or a combination thereof. In one more preferred embodiment, the flame retardant different from the phosphorus-containing monomer represented by Formula (1) includes a vinyl phosphazene compound, and a mass ratio of the phosphorus-containing monomer represented by Formula (1) to the vinyl phosphazene compound is 1:10 to 10:1.

The second aspect of the present disclosure is to provide an article made from the insulating resin composition, and the article includes a prepreg, a resin film, a metal foil-clad laminate or a printed circuit board.

In one preferred embodiment, the article has at least one of following properties:
an inner resin flow between 3 mm and 12 mm;
a length of a stripe at an edge of the article less than or equal to 6 mm;
a total burning time as measured by reference to UL94 of less than or equal to 50 seconds;
a dissipation factor as measured by reference to JIS C2565 of less than or equal to 0.00195;
a peel strength as measured by reference to IPC-TM-650 2.4.8 of greater than or equal to 3.6 lb/in; and
a Z-axis percent of thermal expansion as measured by reference to IPC-TM-650 2.4.24.5 of less than or equal to 1.8%.

In one more preferred embodiment, the article has at least one of following properties:
an inner resin flow between 4.0 mm and 7.5 mm;
a length of a stripe at an edge of the article of 0 mm;
a total burning time as measured by reference to UL94 of less than or equal to 50 seconds;
a dissipation factor as measured by reference to JIS C2565 of less than or equal to 0.00192;
a peel strength as measured by reference to IPC-TM-650 2.4.8 of greater than or equal to 3.6 lb/in; and
a Z-axis percent of thermal expansion as measured by reference to IPC-TM-650 2.4.24.5 of less than or equal to 1.7%.

### Advantageous Effects

The present disclosure can provide an insulating resin composition and an article made therefrom that comprehensively have properties such as suitable inner resin flow, higher flame resistance and peel strength, lower dissipation factor and Z-axis percent of thermal expansion. The insulating resin composition and the article made therefrom may be applied to a prepreg, a resin film, a metal foil-clad laminate and a printed circuit board.

### DETAILED DESCRIPTION

In order to enable those skilled in the art to understand the content of the present disclosure clearly and correctly, the following terms and words in the specification and claims will generally be illustrated and defined. Unless otherwise specified, all terms and symbols used herein (including scientific terms, technical terms, and general symbols, wherein the general symbols include general mathematical symbols, general physical symbols, general chemical symbols, etc.) have the same meanings as those generally understood by those skilled in the art. It should be understood that, unless explicitly defined in the specification, terms and symbols (such as those defined in general dictionaries) should be interpreted as having the meanings consistent with that in the context of the relevant art, and should not be interpreted in an idealized or overly formal meaning.

The term “insulating resin composition” used herein should be interpreted as not including conductive raw materials, such as but not limited to metal particles (such as copper powder), graphene and the like.

The term “containing unsaturated carbon-carbon double bonds” used herein refers to “containing unsaturated C═C double bond groups,” such as but not limited to a vinyl group, a vinylbenzyl group, a (meth)acryloyl group and an allyl group. Among them, the term “vinyl group” should be interpreted as including a vinyl group and a vinylidene group, and “(meth)acryloyl” should be interpreted as including both acryloyl group and methacryloyl group.

Alkyl group, alkenyl group, alkynyl group and other functional groups used herein should be interpreted as including various isomers thereof, for instance, term “alkyl group” refers to a group derived from an aliphatic hydrocarbon and includes a straight chain, a branched chain or a cyclic group. For instance, propyl group should be interpreted as including n-propyl group and isopropyl group. The term “monomer” or “compound” used herein should be interpreted as including various isomers thereof, such as but not limited to structural isomers and stereoisomers.

In the present disclosure, the term “part(s) by weight of” should be interpreted as relative parts by weight, and it may be any weight unit, such as but not limited to kilograms, kilograms, grams, pounds and other weight units.

In the present disclosure, wt % represents weight (or mass) percentage.

In the present disclosure, mil is a unit of thickness, 1 mil is approximately 25.4 μm; ounce is also a unit of thickness, 1 ounce is approximately 35 μm.

In the present disclosure, the term “any one of . . . or a combination thereof” should be interpreted as “any one of the listed elements alone” or “any two of the listed elements in combination” or “any three or more of the listed elements in combination”.

In the present disclosure, numeral ranges expressed with “equal to,” “=,” “greater than or equal to,” “≥,” “less than or equal to,” “≤,” “to,” “˜,” or “−” should be interpreted as including the endpoint values, and all possible sub-ranges and individual numerical values within the range (numerical types include but are not limited to integers, decimals and fractions). For instance, the numeral ranges expressed with “equal to 3.0,” “=3.0,” “greater than or equal to 3.0,” “≥3.0,” “less than or equal to 3.0,” “≤3.0” include the endpoint value “3.0”; the numerical ranges represented by “3.0 to 6.0,” “3.0˜6.0,” and “3.0-6.0” include the endpoint values “3.0” and “6.0,” and should be understood to include but not be limited to sub-ranges such as 3.0-5.0, 4.0-6.0, 5.0-6.0, and single numerical values such as 3.0, 4.0, 5.0, 5.5, 6.0, etc.

In the present disclosure, numeral ranges expressed with “lager than,” “>,” “less than,” “<” should be interpreted as not including the endpoint values. For instance, the numeral ranges expressed with “lager than 3.0,” “>3.0,” “less than 3.0,” “<3.0” do not include the endpoint value “3.0”.

In the present disclosure, the numerical values have precision, with precision determined by the rounding method.

In the present disclosure, polymer includes copolymers and homopolymers (self-polymers). Unless otherwise specified, the degree of polymerization (conversion rate) of the polymer is not limited, for instance, it can be a fully polymerized polymer (where the conversion rate is 100%), or it can be a partially polymerized polymer (where the conversion rate is, such as but not limited to, between 10% and 90%, which can also be referred to as “prepolymer” in the present disclosure).

In the present disclosure, a resin composition obtained by adding different compounds into resin composition after polymerizing them is different from a resin composition obtained by adding different compounds into resin composition without polymerizing them. For instance, a resin composition 1 obtained by adding a polymer of compound A and compound B is different from a resin composition 2 obtained by adding compound A and compound B without polymerizing them, and articles and properties thereof are also different.

The present disclosure will be described below with specific embodiments and examples. The examples are only illustrative of preferred specific embodiments and are not intended to limit the scope of the present disclosure. Unless otherwise specified, materials, methods and conditions adopted in the examples are routine materials, methods and conditions in the field.

As described above, the present disclosure discloses an insulating resin composition, including:
(A): 100 parts by weight of an unsaturated carbon-carbon double bond-containing polyphenylene ether resin and/or a maleimide resin, and
(B): 10 to 65 parts by weight of a phosphorus-containing monomer represented by Formula (1),

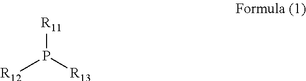

in Formula (1), R₁₁ is a C2 to C4 alkenyl group-substituted phenyl group, and each of R₁₂ and R₁₃ is independently a C1 to C4 alkyl group, a C2 to C4 alkenyl group, a phenyl group, a C1 to C4 alkyl group-substituted phenyl group, a C2 to C4 alkenyl group-substituted phenyl group, a biphenyl group or a naphthyl group.

In one embodiment, the “100 parts by weight of the unsaturated carbon-carbon double bond-containing polyphenylene ether resin and/or the maleimide resin” should be construed as “100 parts by weight of the unsaturated carbon-carbon double bond-containing polyphenylene ether resin” or “100 parts by weight of the maleimide resin” or “a total of 100 parts by weight of the unsaturated carbon-carbon double bond-containing polyphenylene ether resin and the maleimide resin.”

In one embodiment, the phosphorus-containing monomer represented by Formula (1) includes one or more of compounds represented by Formula (1-1) to Formula (1-10),

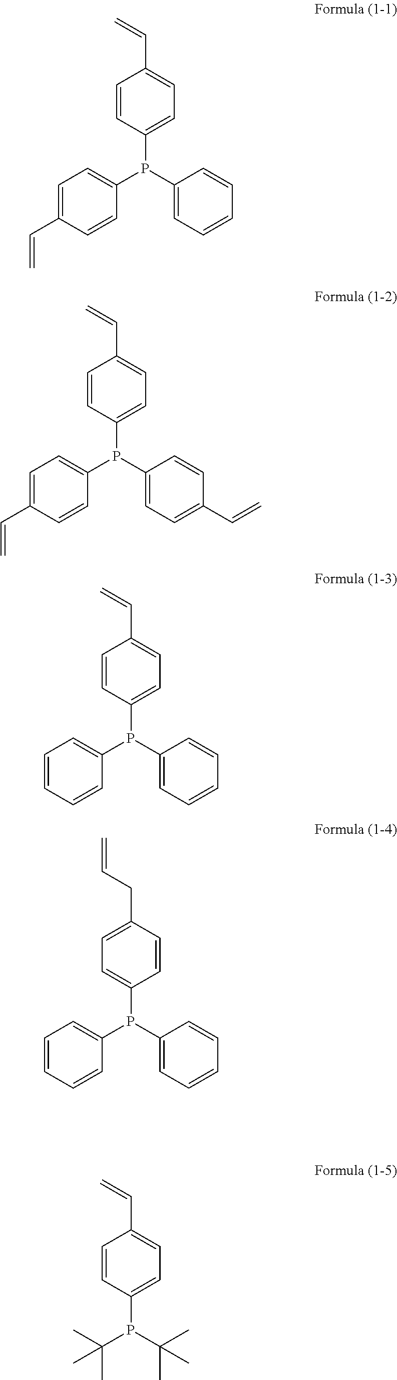

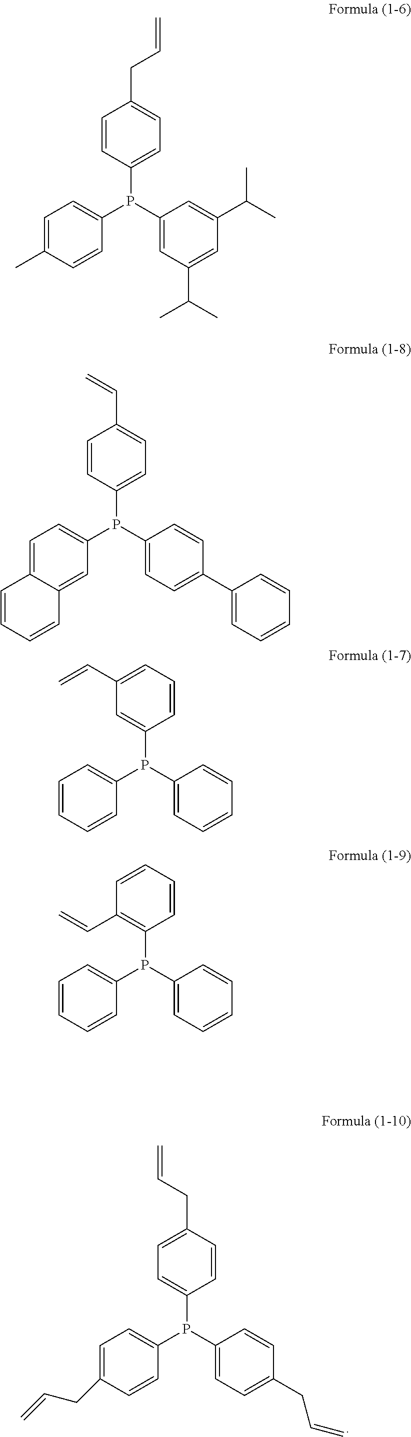

In one preferred embodiment, “the phosphorus-containing monomer represented by Formula (1)” includes any one of “the phosphorus-containing monomer represented by Formula (1) with one C2 to C4 alkenyl group,” “the phosphorus-containing monomer represented by Formula (1) with two C2 to C4 alkenyl group,” “the phosphorus-containing monomer represented by Formula (1) with at least three C2 to C4 alkenyl group” or a combination thereof. Among them, “the phosphorus-containing monomer represented by Formula (1) with one C2 to C4 alkenyl group” is such as but not limited to a compound represented by Formula (1-3), a compound represented by Formula (1-4), a compound represented by Formula (1-5), a compound represented by Formula (1-6), a compound represented by Formula (1-7), a compound represented by Formula (1-8), a compound represented by Formula (1-9); “the phosphorus-containing monomer represented by Formula (1) with two C2 to C4 alkenyl group” is such as but not limited to a compound represented by Formula (1-1); and “the phosphorus-containing monomer represented by Formula (1) with at least three C2 to C4 alkenyl group” is such as but not limited to a compound represented by Formula (1-2) and a compound represented by Formula (1-10).

In one more preferred embodiment, “the phosphorus-containing monomer represented by Formula (1)” includes any two of “the phosphorus-containing monomer represented by Formula (1) with one C2 to C4 alkenyl group,” “the phosphorus-containing monomer represented by Formula (1) with two C2 to C4 alkenyl group,” and “the phosphorus-containing monomer represented by Formula (1) with at least three C2 to C4 alkenyl group” or one of “the phosphorus-containing monomer represented by Formula (1) with two C2 to C4 alkenyl group”. In this case, the insulating resin composition does not include “the phosphorus-containing monomer represented by Formula (1) with one C2 to C4 alkenyl group” alone and does not include “the phosphorus-containing monomer represented by Formula (1) with at least three C2 to C4 alkenyl group” alone.

In the insulating resin composition of the present disclosure, with respect to 100 parts by weight of the unsaturated carbon-carbon double bond-containing polyphenylene ether resin and/or the maleimide resin, the phosphorus-containing monomer represented by Formula (1) may be any single type of the phosphorus-containing monomer represented by Formula (1) or a combination of two or more types of the phosphorus-containing monomer represented by Formula (1), and the total amount of the phosphorus-containing monomer represented by Formula (1) is 10 parts by weight to 65 parts by weight, such as but not limited to 10 parts by weight, 15 parts by weight, 20 parts by weight, 30 parts by weight, 35 parts by weight, 40 parts by weight, 50 parts by weight, 60 parts by weight, and 65 parts by weight of the phosphorus-containing monomer represented by Formula (1).

In one preferred embodiment, the unsaturated carbon-carbon double bond-containing polyphenylene ether resin includes any one of a vinylbenzyl group-containing polyphenylene ether resin, a (meth)acryloyl group-containing polyphenylene ether resin, a vinyl group-containing polyphenylene ether resin, an allyl group-containing polyphenylene ether resin or a combination thereof.

The unsaturated carbon-carbon double bond-containing polyphenylene ether resin applicable to the present disclosure is not particularly limited, and may be any one or more of the unsaturated carbon-carbon double bond-containing polyphenylene ether resin applicable to prepare a prepreg, a resin film, a metal foil-clad laminate or a printed circuit board, and may be any one or more of commercial products, homemade products or a combination thereof, such as but not limited to any one of a vinylbenzyl group-containing polyphenylene ether resin, a (meth)acryloyl group-containing polyphenylene ether resin, a vinyl group-containing polyphenylene ether resin, an allyl group-containing polyphenylene ether resin or a combination thereof.

The unsaturated carbon-carbon double bond-containing polyphenylene ether resin of the present disclosure has unsaturated carbon-carbon double bonds and a phenyl ether backbone. The unsaturated carbon-carbon double bonds act as reactive functional groups, which upon heating, can undergo self-polymerization or undergo free radical polymerization with other components in the resin composition that have unsaturated bonds, and ultimately being crosslinked and cured. The cured product has properties of high thermal resistance and low dielectric. In one preferred embodiment, the unsaturated carbon-carbon double bond-containing polyphenylene ether resin includes the unsaturated carbon-carbon double bond-containing polyphenylene ether resin where the phenyl ether backbone is substituted with 2,6-dimethyl groups. The methyl substitution results in steric hindrance, making it difficult for the oxygen atom on the ether to form hydrogen bonds or van der Waals forces, thereby reducing moisture absorption and resulting in lower dielectric properties.

In one embodiment, the unsaturated carbon-carbon double bond-containing polyphenylene ether resin includes any one of a vinylbenzyl group-containing polyphenylene ether resin with a number average molecular weight of 1000 to 2500 (such as OPE-2st 1200 with a number average molecular weight of 1200, available from Mitsubishi Gas Chemical Co., Inc.; OPE-2st 2200 with a number average molecular weight of 2200, available from Mitsubishi Gas Chemical Co., Inc.), a vinylbenzyl group-containing polyphenylene ether resin with a number average molecular weight of about 2400 to 2800 (such as vinylbenzyl group-modified bisphenol A polyphenylene ether resin), a (meth)acryloyl group-containing polyphenylene ether resin with a number average molecular weight of about 1900 to 2300 (such as SA9000, available from Sabic company), a vinyl group-containing polyphenylene ether resin with a number average molecular weight of about 2200 to 3000, an allyl group-containing polyphenylene ether resin with a number average molecular weight of about 1000 to 4000 or a combination thereof, but the present disclosure is not limited thereto. Among them, the vinyl group-containing polyphenylene ether resin may include various polyphenylene ether resins disclosed in the US Patent Application Publication No. 2016/0185904 A1, all of which are incorporated herein by reference in their entirety. In one embodiment, the vinylbenzyl group-containing polyphenylene ether resin includes but not limited to any one of a vinylbenzyl group-containing biphenyl polyphenylene ether resin, a vinylbenzyl group-modified bisphenol A polyphenylene ether resin or a combination thereof.

In one embodiment, the maleimide resin includes any one of 4,4′-diphenylmethane bismaleimide, polyphenylmethane maleimide (or oligomer of phenylmethane maleimide), bisphenol A diphenyl ether bismaleimide, 3,3′-dimethyl-5,5′-diethyl-4,4′-diphenylmethane bismaleimide, 3,3′-dimethyl-5,5′-dipropyl-4,4′-diphenylmethane bismaleimide, m-phenylene bismaleimide, 4-methyl-1,3-phenylene bismaleimide, 1,6-bismaleimide-(2,2,4-trimethyl)hexane, N-2,3-xylylmaleimide, N-2,6-xylylmaleimide, N-phenylmaleimide, vinyl benzyl maleimide (VBM), indane structure-containing maleimide, isopropyl and meta-arylene structure-containing maleimide, biphenyl structure-containing maleimide, maleimide with aliphatic structure having 10 to 50 carbon atoms or a combination thereof. The compounds should be interpreted as including modifications thereof, such as but not limited to any one of a polymer of diallyl compound and maleimide resin, a polymer of diamine and maleimide resin, a polymer of multifunctional amine and maleimide resin, a polymer of acidic phenolic compound and maleimide resin or a combination thereof.

The example of the maleimide resin includes but not limited to maleimide resin products BMI-1000, BMI-1000H, BMI-1100, BMI-1100H, BMI-2000, BMI-2300, BMI-3000, BMI-3000H, BMI-4000, BMI-5000, BMI-5100, BMI-TMH, BMI-7000 and BMI-7000H available from Daiwakasei Industry Co., Ltd., or maleimide resin products BMI-70 and BMI-80 available from K.I Chemical Industry Co., Ltd., maleimide resin products MIR-3000 or MIR-5000 available from Nippon Kayaku Co., Ltd.

The maleimide resin with an aliphatic structure having 10 to 50 carbon atoms (or imide-extended maleimide resin) may include various imide-extended maleimide resins disclosed in the Taiwan Patent Application Publication No. 200508284A, all of which are incorporated herein by reference in their entirety. The maleimide resin with an aliphatic structure having 10 to 50 carbon atoms of the present disclosure may include but not limited to maleimide resin products BMI-689, BMI-1400, BMI-1500, BMI-1700, BMI-2500, BMI-3000, BMI-5000 and BMI-6000 available from Designer Molecules Inc.

In one embodiment, with respect to 100 parts by weight of the unsaturated carbon-carbon double bond-containing polyphenylene ether resin and/or the maleimide resin, the insulating resin composition of the present disclosure may further include 1 to 100 parts by weight of a polyolefin, preferably 15 to 50 parts by weight of the polyolefin. The polyolefin of the present disclosure includes but not limited to any one of a polybutadiene, a polyisoprene, a styrene-butadiene copolymer, a styrene-isoprene copolymer, a styrene-butadiene-divinylbenzene terpolymer, a maleic anhydride-adducted styrene-butadiene copolymer, a vinyl-polybutadiene-urea ester polymer, a maleic anhydride-adducted polybutadiene, a polymethylstyrene, a hydrogenated polybutadiene, a hydrogenated polyisoprene, a hydrogenated styrene-butadiene-divinylbenzene copolymer, a hydrogenated styrene-butadiene-styrene copolymer, a hydrogenated maleic anhydride-adducted styrene-butadiene copolymer, a hydrogenated styrene-butadiene copolymer, a hydrogenated styrene-isoprene copolymer, a divinylbenzene-styrene-ethylstyrene copolymer, a divinylbenzene-styrene-ethylene terpolymer.

The divinylbenzene-styrene-ethylstyrene copolymer of the present disclosure may include various divinylbenzene-styrene-ethylstyrene copolymer disclosed in the US Patent Application Publication No. 2007/0129502 A1, all of which are incorporated herein by reference in their entirety.

In one embodiment, the insulating resin composition of the present disclosure may further include any one of a benzoxazine resin, an epoxy resin, a polyester resin, a phenolic resin, an amine curing agent, a polyamide, a polyimide, a styrene maleic anhydride, a cyanate ester resin, a maleimide triazine resin or a combination thereof.

In the insulating resin composition of the present disclosure, with respect to 100 parts by weight of the unsaturated carbon-carbon double bond-containing polyphenylene ether resin and/or the maleimide resin, benzoxazine resin, the amount of the epoxy resin, polyester resin, phenolic resin, polyamide, polyimide, styrene maleic anhydride, cyanate ester resin or maleimide triazine resin is not specifically limited, and may be adjust as needed. For instance, the amount may be 1 part by weight to 100 parts by weight, including but not limited to 1 part by weight, 10 parts by weight, 15 parts by weight, 20 parts by weight, 25 parts by weight, 50 parts by weight or 100 parts by weight. With respect to 100 parts by weight of the unsaturated carbon-carbon double bond-containing polyphenylene ether resin and/or the maleimide resin, the amount of the amine curing agent is not specifically limited, and may be 1 to 15 parts by weight, including but not limited to 1 part by weight, 4 parts by weight, 7.5 parts by weight, 12 parts by weight or 15 parts by weight.

In the present disclosure, the benzoxazine resin may be various benzoxazine resins known in the field. The specific example includes but not limited to any one of a bisphenol A benzoxazine resin, a bisphenol F benzoxazine resin, a phenolphthalein benzoxazine resin, a dicyclopentadiene benzoxazine resin, a phosphorus-containing benzoxazine resin, a diamine benzoxazine resin, a phenyl group-modified benzoxazine resin, a vinyl group-modified benzoxazine resin, an allyl-modified benzoxazine resin or a combination thereof. The suitable commercial benzoxazine resin products include LZ-8270 (phenolphthalein benzoxazine resin), LZ-8298 (phenolphthalein benzoxazine resin), LZ-8280 (bisphenol F benzoxazine resin), LZ-8290 (bisphenol A benzoxazine resin) available from Huntsman, or KZH-5031 (vinyl group-modified benzoxazine resin), KZH-5032 (phenyl-modified benzoxazine resin) available from Kolon Industries. Among them, the diamine benzoxazine resin may be any one of a diaminodiphenylmethane benzoxazine resin, a diaminodiphenyl ether benzoxazine resin, a diaminodiphenyl sulfone benzoxazine resin, a diaminodiphenyl sulfide benzoxazine resin or a combination thereof.

In the present disclosure, the epoxy resin may be various epoxy resins known in the field. For improving the thermal resistance of the resin composition, the epoxy resin includes any one of a bisphenol A epoxy resin, a bisphenol F epoxy resin, a bisphenol S epoxy resin, a bisphenol AD epoxy resin, a novolac epoxy resin, a trifunctional epoxy resin, a tetrafunctional epoxy resin, a multifunctional novolac epoxy resin, dicyclopentadiene (DCPD) epoxy resin, a phosphorus-containing epoxy resin, a p-xylene epoxy resin, a naphthalene epoxy resin (such as naphthol epoxy resin), a benzofuran epoxy resin, a isocyanate-modified epoxy resin or a combination thereof, but the present disclosure is not limited thereto. Among them, the novolac epoxy resin may be a phenol novolac epoxy resin, a bisphenol A novolac epoxy resin, a bisphenol F novolac epoxy resin, a biphenyl novolac epoxy resin, a phenol benzaldehyde epoxy resin, a phenol aralkyl novolac epoxy resin or a o-cresol novolac epoxy resin. The phosphorus-containing epoxy resin may be DOPO (9,10-dihydro-9-oxa-10-phosphaphenanthrene-10-oxide) epoxy resin, DOPO-HQ epoxy resin and the like. The DOPO epoxy resin may be one or more selected from DOPO-containing phenol novolac epoxy resin, DOPO-containing o-cresol novolac epoxy resin and DOPO-containing bisphenol-A novolac epoxy resin. The DOPO-HQ epoxy resin may be one or more selected from DOPO-HQ-containing phenol novolac epoxy resin, DOPO-HQ-containing o-cresol novolac epoxy resin and DOPO-HQ-containing bisphenol-A novolac epoxy resin.

In the present disclosure, the polyester resin may be various polyester resins known in the field. The specific example includes but not limited to a dicyclopentadiene-containing polyester resin and a naphthalene-containing polyester resin, including but not limited to polyester resin products HPC-8000 or HPC-8150 available from DIC Corporation.

In the present disclosure, the phenolic resin may be various phenolic resins known in the field. The specific example includes but not limited to any one of a phenol phenolic resin, an o-methylphenol phenolic resin, a bisphenol A phenolic resin, a naphthol phenolic resin, a biphenyl phenolic resin, a dicyclopentadiene phenolic resin, a phenoxy resin or a combination thereof.

In the present disclosure, the amine curing agent may be various amine curing agents known in the field. The specific example includes but not limited to any one of a diaminodiphenyl sulfone, a diaminodiphenylmethane, a diaminodiphenyl ether, a diaminodiphenyl sulfide, a dicyandiamide or a combination thereof.

In the present disclosure, the polyamide may be various polyamides known in the field. The specific example includes but not limited to any commercially available polyamide resin products.

In the present disclosure, the polyimide may be various polyimides known in the field. The specific example includes but not limited to any commercially available polyimide resin products.

In the present disclosure, the styrene maleic anhydride (SMA) may be various styrene maleic anhydrides known in the field, and the molar ratio of styrene (St) to maleic anhydride (MA) may be 1/1, 2/1, 3/1, 4/1, 6/1, 8/1 or 12/1. The specific example includes but not limited to styrene maleic anhydride copolymer products SMA-1000, SMA-2000, SMA-3000, EF-30, EF-40, EF-60 and EF-80 available from Cray Valley, or styrene maleic anhydride copolymer products C400, C500, C700, C900 available from Polyscope.

In the present disclosure, the cyanate ester resin may be various cyanate ester resins known in the field, such as a compound having a structure of Ar—O—C≡N, where the Ar may be a substituted or unsubstituted aromatic group. For improving the thermal resistance of the resin composition, the cyanate ester includes but not limited to any one of a novolac cyanate ester resin, a bisphenol A cyanate ester resin, a bisphenol F cyanate ester resin, a dicyclopentadiene-containing cyanate ester resin, a naphthalene-containing cyanate ester resin, a phenolphthalein cyanate ester resin, an adamantane cyanate ester resin, a fluorene cyanate ester resin or a combination thereof. Among them, the novolac cyanate ester resin includes any one of a bisphenol A novolac cyanate ester resin, a bisphenol F novolac cyanate ester resin or a combination thereof. The cyanate ester resin may be cyanate ester resin products such as but not limited to Primaset PT-15, PT-30S, PT-60S, BA-200, BA-230S, BA-3000S, BTP-2500, BTP-6020S, DT-4000, DT-7000, ULL950S, HTL-300, CE-320, LVT-50, LeCy available from Arxada AG.

In the present disclosure, the maleimide triazine resin may be various maleimide triazine resins known in the field. The specific example includes but not limited to any one of a maleimide triazine resin obtained by polymerizing a maleimide resin and a bisphenol A cyanate ester resin, a maleimide triazine resin obtained by polymerizing a maleimide resin and a bisphenol F cyanate ester resin, a maleimide triazine resin obtained by polymerizing a maleimide resin and a phenol novolac cyanate ester resin, a maleimide triazine resin obtained by polymerizing a maleimide resin and a dicyclopentadiene-containing cyanate ester resin or a combination thereof. In one embodiment, the maleimide triazine resin may be obtained by polymerizing the maleimide resin and the cyanate ester resin mentioned above in any molar ratio. For instance, the molar ratio of maleimide resin to cyanate ester resin may be 1:1 to 1:10, such as but not limited to 1:1, 1:2, 1:4, 1:6, 1:8 or 1:10.

In one embodiment, the insulating resin composition may further include any one of a flame retardant different from the phosphorus-containing monomer represented by Formula (1), a curing accelerator, a polymerization inhibitor, an inorganic filler, a solvent, a silane coupling agent, a surfactant, a coloring agent, a toughening agent or a combination thereof.

In the present disclosure, the flame retardant different from the phosphorus-containing monomer represented by Formula (1) may be one or more of the flame retardant different from the phosphorus-containing monomer represented by Formula (1) applicable to prepare a prepreg, a resin film, a metal foil-clad laminate or a printed circuit board, such as but not limited to a phosphorus-containing flame retardant or a bromine-containing flame retardant different from the phosphorus-containing monomer represented by Formula (1). The bromine-containing flame retardant different from the phosphorus-containing monomer represented by Formula (1) preferably includes decabromodiphenylethane. The phosphorus-containing flame retardant different from the phosphorus-containing monomer represented by Formula (1) preferably includes any one of hydroquinone bis-(diphenyl phosphate), bisphenol A bis-(diphenylphosphate), tri(2-carboxyethyl) phosphine (TCEP), tris(chloroisopropyl) phosphate, trimethyl phosphate (TMP), dimethyl methyl phosphonate (DMMP), resorcinol bis(dixylenyl phosphate) (RDX, such as products PX-200, PX-201 and PX-202), phosphazene (such as products SPB-100 and SPH-100 which do not contain unsaturated carbon-carbon double bonds, allyl phosphazene compound product SPV-100 or commercially available or selfmade vinyl phosphazene compounds), ammonium polyphosphate, melamine polyphosphate, 9,10-dihydro-9-oxa-10-phosphaphenanthrene-10-oxide (DOPO) and its derivatives (such as di-DOPO compounds) or resins, diphenylphosphine oxide (DPPO) and its derivatives (such as di-DPPO compounds) or resins, melamine cyanurate, trishydroxyethyl isocyanurate, aluminium phosphinate (such as products OP-930 and OP-935) or a combination thereof.

In one embodiment, the flame retardant different from the phosphorus-containing monomer represented by Formula (1) may be a flame retardant available from Katayama Chemical Industries Co., Ltd., such as but not limited to any one of V1, V2, V3, V4, V5, V7, S-2, S-4, E-4c, E-7c, E-8g, E-9g, E-10g, E-100, B-3, W-1o, W-2h, W-2o, W-3o, W-4o, OX-1, OX-2, OX-4, OX-6, OX-6+, OX-7, OX-7+, OX-13, BPE-1, BPE-3, HyP-2, API-9, CMPO, ME-20, C-1R, C-1S, C-3R, C-3S, C-11R or a combination thereof.

In one embodiment, with respect to 100 parts by weight of the unsaturated carbon-carbon double bond-containing polyphenylene ether resin and/or the maleimide resin, the insulating resin composition of the present disclosure may further include 1 part by weight to 100 parts by weight of a flame retardant different from the phosphorus-containing monomer represented by Formula (1), preferably 5 parts by weight to 80 parts by weight of the flame retardant different from the phosphorus-containing monomer represented by Formula (1), more preferably 5 parts by weight to 50 parts by weight of the flame retardant different from the phosphorus-containing monomer represented by Formula (1).

In one preferred embodiment, with respect to 100 parts by weight of the unsaturated carbon-carbon double bond-containing polyphenylene ether resin and/or the maleimide resin, the insulating resin composition of the present disclosure may further include 1 parts by weight to 100 parts by weight of a vinyl phosphazene compound, and the vinyl phosphazene compound includes but not limited to any one of selfmade or commercially available vinylphenoxy cyclotriphosphazene, vinylphenoxy cyclotetraphosphazene, vinylphenoxy cyclopentaphosphazene, vinylphenoxy cyclohexaphosphazene or a combination thereof.

The number of the vinylphenoxy group in the vinylphenoxy cyclotriphosphazene may be 6, 5, 4, 3, 2 or 1, and the corresponding number of the phenoxy group may be 0, 1, 2, 3, 4 or 5, and the total number of the vinylphenoxy group and the phenoxy group is 6. For instance, a vinylphenoxy cyclotriphosphazene containing 6 vinylphenoxy groups and 0 phenoxy groups is hexa(vinylphenoxy)cyclotriphosphazene, a vinylphenoxy cyclotriphosphazene containing 3 vinylphenoxy groups and 3 phenoxy groups is tris(vinylphenoxy)triphenoxycyclotriphosphazene, and a vinylphenoxy cyclotriphosphazene containing 1 vinylphenoxy group and 5 phenoxy groups is (vinylphenoxy)pentaphenoxycyclotriphosphazene. The number of the vinylphenoxy group in the vinylphenoxycyclotetraphosphazene may be 8, 7, 6, 5, 4, 3, 2, or 1, and the corresponding number of the phenoxy groups may be 0, 1, 2, 3, 4, 5, 6, or 7, and the total number of the vinylphenoxy group and the phenoxy group is 8. The number of the vinylphenoxy groups in the vinylphenoxy cyclopentaphosphazene may be 10, 9, 8, 7, 6, 5, 4, 3, 2 or 1, and the corresponding number of the phenoxy group may be 0, 1, 2, 3, 4, 5, 6, 7, 8 or 9, and the total number of the vinylphenoxy group and the phenoxy group is 10. The number of the vinylphenoxy group in the vinylphenoxy cyclohexaphosphazene may be 12, 11, 10, 9, 8, 7, 6, 5, 4, 3, 2 or 1, and the corresponding number of the phenoxy group may be 0, 1, 2, 3, 4, 5, 6, 7, 8, 9, 10 or 11, and the total number of the vinylphenoxy group and the phenoxy group is 12. The substitution position of the vinyl group in the vinylphosphazene compound may be any one of ortho, para, and meta positions, or a combination thereof.

In one embodiment, the mass ratio of the phosphorus-containing monomer represented by Formula (1) to the vinyl phosphazene compound is between 1:10 and 10:1, preferably between 1:4 and 4:1. By using the phosphorus-containing monomer represented by Formula (1) in combination with the vinyl phosphazene compound and controlling the mass ratio thereof, the effects of the two flame retardants can be synergistically exerted. Compared to using the phosphorus-containing monomer represented by Formula (1) alone or using the vinyl phosphazene compound alone, using the phosphorus-containing monomer represented by Formula (1) in combination with the vinyl phosphazene compound, can further improve the flame resistance and glass transition temperature of the article and reduce the Z-axis percent of thermal expansion while maintaining a low dissipation factor.

In one embodiment, with respect to 100 parts by weight of the unsaturated carbon-carbon double bond-containing polyphenylene ether resin and/or the maleimide resin, the insulating resin composition of the present disclosure may further include 0.001 parts by weight to 5 parts by weight of a curing accelerator, preferably 0.01 parts by weight to 3 parts by weight of the curing accelerator, more preferably 0.1 parts by weight to 1.0 parts by weight of the curing accelerator. The curing accelerator includes a catalyst, such as a Lewis base or a Lewis acid, and a curing initiator. Among them, the Lewis base includes any one of imidazole, boron trifluoride amine complex, ethyltriphenyl phosphonium chloride, 2-methylimidazole (2MI), 2-phenyl-1H-imidazole (2PZ), 2-ethyl-4-methylimidazole (2E4MZ), triphenylphosphine (TPP) and 4-dimethylaminopyridine (DMAP) or a combination thereof. The Lewis acid includes metal salt compounds, such as metal salt compounds of manganese, iron, cobalt, nickel, copper and zinc. The specific examples may be zinc octanoate or cobalt octanoate. The curing initiator includes any one of a peroxide capable of producing free radicals, such as but not limited to dicumyl peroxide (DCP), tert-butyl perbenzoate, dibenzoyl peroxide (BPO), 2,5-dimethyl-2,5-di(tert-butylperoxy)-3-hexyne, di-tert-butyl peroxide, bis(tert-butylperoxyisopropyl)benzene or a combination thereof.

In one embodiment, with respect to 100 parts by weight of the unsaturated carbon-carbon double bond-containing polyphenylene ether resin and/or the maleimide resin, the insulating resin composition of the present disclosure may further include 0.001 parts by weight to 20 parts by weight of a polymerization inhibitor, preferably 0.001 parts by weight to 10 parts by weight of the polymerization inhibitor, more preferably 0.001 parts by weight to 1 parts by weight of the polymerization inhibitor. The polymerization inhibitor includes but not limited to any one of 1,1-diphenyl-2-picrylhydrazyl free radical, methyl acrylonitrile, nitroxide stable free radical inhibitor, triphenylmethyl radical polymerization inhibitor, metal ion radical polymerization inhibitor, sulfur radical polymerization inhibitor (including but not limited to disulfide ester), hydroquinone, p-methoxyphenol, p-benzoquinone, phenothiazine, 0-phenylnaphthylamine, p-tert-butylcatechol, methylene blue, 4,4′-butylidenebis(6-tert-butyl-3-methylphenol), 2,2′-methylenebis(4-ethyl-6-t-butylphenol), galvinoxyl free radical polymerization inhibitor or a combination thereof. Among them, the nitroxide stable free radical inhibitor includes but not limited to 2,2,6,6-tetramethyl-1-oxy-piperidin, nitroxide radicals derived from cyclic hydroxylamines (such as 2,2,6,6-substituted piperidine 1-oxyl free radical polymerization inhibitor or 2,2,5,5-substituted pyrrolidine 1-oxyl free radical polymerization inhibitor, where the substituents are preferably C1 to C4 alkyl group such as methyl group). The nitroxide stable free radical inhibitor includes any one of 2,2,6,6-tetramethylpiperidin-1-oxyl free radical polymerization inhibitor, 2,2,6,6-tetraethylpiperidin-1-oxyl free radical polymerization inhibitor, 2,2,6,6-tetramethyl-4-oxopiperidin-1-oxyl free radical polymerization inhibitor, 2,2,5,5-tetramethylpyrrolidine-1-oxyl free radical polymerization inhibitor, 1,1,3,3-tetramethyl-2-iso-dihydroindole superoxide radical polymerization inhibitor, N,N-di-tert-butylamine oxygen free radical polymerization inhibitor or a combination thereof. The polymerization inhibitor applicable to the insulating resin composition of the present disclosure also includes the products derived from the polymerization inhibitor with its hydrogen atom or group substituted by other atom or group, such as products derived from a polymerization inhibitor with its hydrogen atom substituted by an amino group, a hydroxyl group, a carbonyl group or the like.

In one embodiment, with respect to 100 parts by weight of the unsaturated carbon-carbon double bond-containing polyphenylene ether resin and/or the maleimide resin, the insulating resin composition of the present disclosure may further include 10 parts by weight to 300 parts by weight of an inorganic filler, preferably 80 parts by weight to 300 parts by weight of the inorganic filler, more preferably 100 parts by weight to 200 parts by weight of the inorganic filler. The inorganic filler may be any one or more of the inorganic fillers applicable to prepare a prepreg, a resin film, a metal foil-clad laminate or a printed circuit board, such as but not limited to any one of silica (fused, non-fused, porous or hollow type), aluminum oxide, aluminum hydroxide, magnesium oxide, magnesium hydroxide, calcium carbonate, aluminum nitride, boron nitride, aluminum silicon carbide, silicon carbide, titanium dioxide, barium titanate, lead titanate, strontium titanate, calcium titanate, magnesium titanate, barium zirconate, lead zirconate, magnesium zirconate, lead zirconate titanate, zinc molybdate, calcium molybdate, magnesium molybdate, ammonium molybdate, zinc molybdate-modified talc, zinc oxide, zirconium oxide, mica, boehmite (AlOOH), calcined talc, talc, silicon nitride, zirconium tungstate, petalite, calcined kaoli or a combination thereof. The shape of the inorganic filler is not specifically limited, and the inorganic filler may be spherical (including solid sphere or hollow sphere), fibrous, plate-like, particulate, flake-like or whisker-like. The inorganic filler is preferably pretreated by a silane coupling agent. The color of the inorganic filler is not particularly limited, and may be white, black, light yellow, etc. The preparation method of the inorganic filler is also not particularly limited. For instance, the preparation method of the spherical inorganic filler may be a known method such as a melting method, a chemical synthesis method and a direct combustion method.

The solvent applicable to the insulating resin composition of the present disclosure includes any one of methanol, ethanol, ethylene glycol monomethyl ether, acetone, butanone (i.e., methyl ethyl ketone or MEK), methyl isobutyl ketone, cyclohexanone, N-methylpyrrolidone, toluene, xylene, methoxyethyl acetate, ethoxyethyl acetate, propoxyethyl acetate, ethyl acetate, dimethyl formamide, dimethyl acetamide, propylene glycol methyl etheracetate, or a mixed solvent thereof. The amount of the solvent is intended to completely dissolve the resin and adjust the total solid content of the resin composition to a specific total solid content. In one preferred embodiment, the amount of solvent is adjusted to a total solid content of the resin composition of 50% to 85% (weight percentage).

In one embodiment, with respect to 100 parts by weight of the unsaturated carbon-carbon double bond-containing polyphenylene ether resin and/or the maleimide resin, the insulating resin composition of the present disclosure may further include 0.001 parts by weight to 20 parts by weight of a silane coupling agent, preferably 0.01 parts by weight to 10 parts by weight of the silane coupling agent. The silane coupling agent includes silane (including but not limited to siloxane), and the silane includes any one of amino silane, epoxide silane, vinyl silane, hydroxyl silane, isocyanate silane, methacryloyloxyl silane, acryloyloxyl silane or a combination thereof.

In one embodiment, with respect to 100 parts by weight of the unsaturated carbon-carbon double bond-containing polyphenylene ether resin and/or the maleimide resin, the insulating resin composition of the present disclosure may further include 0.001 parts by weight to 10 parts by weight of a surfactant, preferably 0.01 parts by weight to 5 parts by weight of surfactant. The main purpose of adding the surfactant in the present disclosure is to make the filler uniformly disperse in the insulating resin composition. The type of the surfactant applicable to the insulating resin composition of the present disclosure is not specifically limited.

In one embodiment, with respect to 100 parts by weight of the unsaturated carbon-carbon double bond-containing polyphenylene ether resin and/or the maleimide resin, the insulating resin composition of the present disclosure may further include 0.001 parts by weight to 10 parts by weight of a coloring agent, preferably 0.01 parts by weight to 5 parts by weight of the coloring agent. The coloring agent includes but not limited to known dye or pigment.

In one embodiment, with respect to 100 parts by weight of the unsaturated carbon-carbon double bond-containing polyphenylene ether resin and/or the maleimide resin, the insulating resin composition of the present disclosure may further include 1 part by weight to 50 parts by weight of toughening agent, preferably 3 parts by weight to 10 parts by weight of the toughening agent. In the present disclosure, the main purpose of the toughening agent is to improve the toughness of the insulating resin composition. The toughening agent applicable to the present disclosure includes but not limited to any one of carboxyl-terminated butadiene acrylonitrile rubber (CTBN), core-shell rubber, ethylene-propylene rubber or a combination thereof.

The present disclosure also provides an article made from the insulating resin composition, such as components in various electronic products, including a prepreg, a resin film, a metal foil-clad laminate or a printed circuit board.

The insulating resin composition of the present disclosure may be made into a prepreg, which includes a reinforcement material and a layered structure disposed thereon. The layered structure is formed by heating the insulating resin composition at a high temperature to a semi-cured state (B-stage). The baking temperature for making the prepreg is between 120° C. and 180° C., preferably between 120° C. and 160° C. The reinforcement material may be any one of fiber material, woven fabric and non-woven fabric. The woven fabric preferably includes fiberglass fabrics. The types of the fiberglass fabrics are not particularly limited and may be various fiberglass fabrics applicable to printed circuit boards, such as E-glass fabric, D-glass fabric, S-glass fabric, T-glass fabric, L-glass fabric, Q-glass fabric or QL-glass fabric (a glass fabric of a mixed structure made of Q-glass fabric and L-glass fabric); and the type of the fiberglass includes yarns and rovings, in spread form or standard form, and the end face shapes may be round or flat. The non-woven fabric preferably includes liquid crystal resin non-woven fabric, such as polyester non-woven fabric, polyurethane non-woven fabric and so on. The woven fabric may also include liquid crystal resin woven fabric, such as polyester woven fabric, polyurethane woven fabric and so on. The reinforcement material may increase the mechanical strength of the prepreg. In one preferred embodiment, the reinforcement material may be pre-treated by a silane coupling agent. The prepreg is subsequently heated and cured (C-stage) to form an insulating layer.

The insulating resin composition of the present disclosure may be made into a resin film, which is prepared by heating and baking to semi-cure the insulating resin composition. The insulating resin composition may be selectively coated on a supporting material, which includes a liquid crystal resin film, a polytetrafluoroethylene film, a polyethylene terephthalate film (PET film), a polyimide film (PI film), a metal foil (such as a copper foil) or a resin-coated copper (RCC), followed by heating and baking to a semi-cured state so as to make the resin composition into the resin film.

The insulating resin composition of the present disclosure may be made into various metal foil-clad laminates (metallic clad laminates), which include at least two metal foils and at least one insulation layer disposed between the two metal foils. The insulation layer may be made by curing the resin composition at high temperature and high pressure to C-stage, wherein a suitable curing temperature may be between 190° C. and 220° C., preferably between 200° C. and 210° C., a curing time may be 90 to 180 minutes, preferably 120 to 150 minutes, and a laminating pressure may be between 300 psi and 550 psi, preferably between 400 psi and 550 psi. The insulation layer may be formed by curing the prepreg or the resin film to C-stage. The material of the metal foil may be copper, aluminum, nickel, platinum, silver, gold, or alloy thereof, such as copper. In one preferred embodiment, the metal foil-clad laminate is a copper-clad laminate (CCL).

In one embodiment, the metal foil-clad laminate may be further processed through a circuit processing to form a printed circuit board. In one embodiment, the preparing method of the printed circuit board is as the following: a double-sided copper-clad laminate (such as product EM-827, available from Elite Electronic Material (Kunshan) Co., Ltd.) with a thickness of 28 mil and having 1-ounce (oz) HTE (High Temperature Elongation) copper foils may be used and subject to drilling (drilling method such as but not limited to mechanical drilling and laser drilling) and then electroplating, so as to form an electrical conduction between the upper layer copper foil and the bottom layer copper foil. Then, the upper layer copper foil and the bottom layer copper foil are etched to form an inner layer circuit board. Then, brown oxidation and roughening processes are performed on the inner layer circuit board to form uneven structures on the surface to increase roughness. Next, a copper foil, the prepreg (or resin film), the inner layer circuit board, the prepreg and a copper foil are stacked in sequence, and then heated at 190° C. to 220° C. for 90 minutes to 180 minutes by a vacuum lamination apparatus to cure the semi-cured material of the insulation layer, thereby obtaining a printed circuit board. Optionally, black oxidation, drilling, copper plating and other processes known in the field may further performed on the printed circuit board.

In one embodiment, the article made from the insulating resin composition includes a reinforcement material or a supporting material and a semi-cured or cured product obtained by heating and chemically cross-linking the resin composition.

The present disclosure also provides a resin cured product made from the insulating resin composition. In one embodiment, the insulating resin composition is subjected to heating and chemical cross-linking curing (C-stage) to obtain the resin cured product. For instance, the curing temperature applicable to the heating process is between 150° C. and 250° C. (preferably between 190° C. and 220° C.), and the curing time is 90 to 240 minutes (preferably 120 to 180 minutes). The shape of the resin cured product is not particularly limited, and may be in the form of layers, blocks, particles, etc. The method for preparing the resin cured product is not particularly limited. The resin cured product may be obtained by placing it in a mold of a specific shape and heating it to be completely cured, or by coating it on a supporting material and heating it to be completely cured. The mold of specific shape includes but are not limited to laminates or printed circuit boards with grooves, holes or circuit open areas. In one embodiment, the insulating resin composition is coated on a supporting material and then heated and chemically cross-linked to obtain a resin cured product containing the support material. The supporting material includes but not limited to a liquid crystal resin film, a polytetrafluoroethylene film (PTFE film), a polyethylene terephthalate film (PET film), a polyimide film (PI film) and a metal foil (preferably copper foil).

In one embodiment, the articles made from the insulating resin composition disclosed by the present disclosure have at least one of the following properties:
an inner resin flow rating of level A or level B (i.e., at least level B, where the inner resin flow is between 3 and 12 mm);
a length of a stripe at an edge of the article less than or equal to 6 mm, such as less than or equal to 5.7 mm, or 0 mm;
a total burning time as measured by reference to UL94 of less than or equal to 50 seconds, such as 26 to 50 seconds;
a dissipation factor as measured by reference to JIS C2565 of less than or equal to 0.00195, such as 0.00175 to 0.00195;
a peel strength as measured by reference to IPC-TM-650 2.4.8 of greater than or equal to 3.6 lb/in, such as 3.6 to 4.0 lb/in;
a Z-axis percent of thermal expansion as measured by reference to IPC-TM-650 2.4.24.5 of less than or equal to 1.8%, such as 1.2 to 1.8%.

In one preferred embodiment, the articles made from the insulating resin composition disclosed by the present disclosure have at least one of the following properties:
an inner resin flow rating of level A (where the inner resin flow is between 4.0 to 7.5 mm);
a length of a stripe at an edge of the article equal to 0 mm (that is, no stripe);
a total burning time as measured by reference to UL94 of less than or equal to 50 seconds, such as 26 to 50 seconds;
a dissipation factor as measured by reference to JIS C2565 of less than or equal to 0.00192, such as 0.00175 to 0.00192;
a peel strength as measured by reference to IPC-TM-650 2.4.8 of greater than or equal to 3.6 lb/in, such as 3.6 to 4.0 lb/in;
a Z-axis percent of thermal expansion as measured by reference to IPC-TM-650 2.4.24.5 of less than or equal to 1.7%, such as 1.2 to 1.7%.

Raw materials below are used to prepare the resin compositions of Examples and Comparative Examples of the present disclosure according to the amount listed in Table 1 to Table 4 and further made into testing samples.

The raw materials used in Examples and Comparative Examples of the present disclosure are described as follows:
Phosphorus-containing monomer represented by Formula (1-1) to Formula (1-7), available from Shanghai Aladdin Biochemical Technology Co., Ltd.
SA9000: (meth)acryloyl group-containing polyphenylene ether resin, available from Sabic.
OPE-2st 1200: vinylbenzyl group-containing polyphenylene ether resin, available from Mitsubishi Gas Chemical Co., Inc.
OPE-2st 2200: vinylbenzyl group-containing polyphenylene ether resin, available from Mitsubishi Gas Chemical Co., Inc.
BMI-5100: 3,3′-dimethyl-5,5′-diethyl-4,4′-diphenylmethane bismaleimide, available from Daiwakasei Industry Co., Ltd.
BMI-2300: polyphenylmethane bismaleimide, available from Daiwakasei Industry Co., Ltd.
Maleimide resin represented by Formula (3): isopropyl and meta-arylene structure-containing maleimide, commercially available, having a structure shown below,

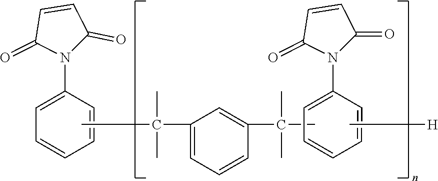

wherein n is an integer from 1 to 10.
Maleimide resin represented by Formula (4): biphenyl structure-containing maleimide, commercially available, having a structure shown below,

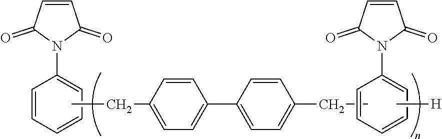

wherein n is an integer from 1 to 10.
Maleimide resin represented by Formula (5): indane structure-containing maleimide, commercially available, having a structure shown below,

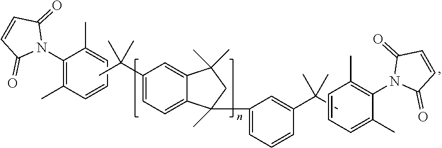

wherein n is a numeral between 0.95 and 10.
B-3000: polybutadiene, available from Nippon Soda Co., Ltd.
Ricon 100: styrene-butadiene copolymer, available from Cray Valley.
H1041: hydrogenated styrene-butadiene-styrene copolymer, available from Asahi Kasei.
Ricon 184MA6: maleic anhydride-adducted styrene-butadiene copolymer, available from Cray Valley.
Divinylbenzene-styrene-ethylstyrene copolymer (DVB-St-EtSt), available from NIPPON STEEL Chemical & Material Co., Ltd.
Phosphorus-free cross-linking monomer: having a structure shown below, available from Kingyorker enterprise Co., Ltd.

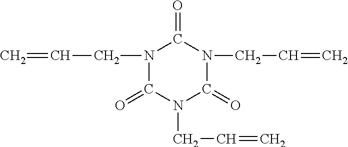 [SMILES: C=CCn1c(=O)n(CC=C)c(=O)n(CC=C)c1=O]

Hexa(4-vinylphenoxy)cyclotriphosphazene, commercially available, having a structure shown below.

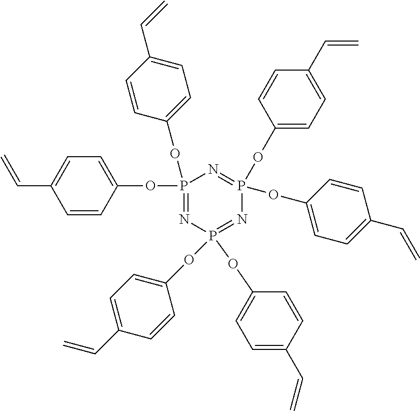 [SMILES: C=Cc1ccc(OP2(Oc3ccc(C=C)cc3)=NP(Oc3ccc(C=C)cc3)(Oc3ccc(C=C)cc3)=NP(Oc3ccc(C=C)cc3)(Oc3ccc(C=C)cc3)=N2)cc1]

Allyldiphenylphosphine, commercially available, having a structure shown below.

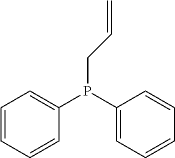 [SMILES: C=CCP(c1ccccc1)c1ccccc1]

Triphenylphosphine, commercially available, having a structure shown below.

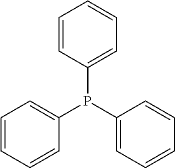 [SMILES: c1ccc(P(c2ccccc2)c2ccccc2)cc1]

Diethyl 4-vinylbenzylphosphonate, available from Katayama Chemical Industries Co., Ltd.

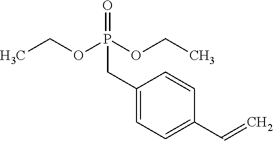 [SMILES: C=Cc1ccc(CP(=O)(OCC)OCC)cc1]

Tri(4-vinylbenzene)phosphine sulfide, commercially available, having a structure shown below.

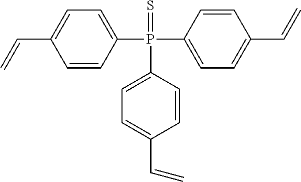 [SMILES: C=Cc1ccc(P(=S)(c2ccc(C=C)cc2)c2ccc(C=C)cc2)cc1]

25B: 2,5-dimethyl-2,5-di(tert-butylperoxy)-3-hexyne, available from NOF Corporation.

Chemically synthesized spherical silicon dioxide: a spherical silica with a median particle size D₅₀ of about 1.5±0.5 jam, which is prepared by the alkaline hydrolytic polycondensation and treated by a silane coupling agent, commercially available.

Solvent: a mixed solvent of toluene and MEK, the parts by weight ratio of them is 1:1, and the toluene and MEK are commercially available. The amount of solvents is shown as “PA” in the Tables to indicate a “proper amount,” which represents an amount of solvents is adjusted so that a solid content (S/C) of the whole resin composition is 60% to 68% (S/C=60% to 68%).

Components and property testing results of the insulating resin composition of Examples and Comparative Examples are shown in Table 1 to Table 4:

TABLE 1
The components (in parts by weight) and the property testing
results of the resin composition of Examples E1 to E6

| Components | | E1 | E2 | E3 | E4 | E5 | E6 |
|---|---|---|---|---|---|---|---|
| Phosphorus- | Formula (1-3) | 30 | — | — | — | — | — |
| containing | Formula (1-4) | — | 10 | — | — | — | — |
| monomer | Formula (1-5) | — | — | 10 | — | — | — |
| represented by | Formula (1-6) | — | — | — | 40 | — | — |
| Formula (1) | Formula (1-7) | — | — | — | — | — | — |
| | Formula (1-1) | — | — | — | — | — | 30 |
| | Formula (1-2) | — | — | — | — | 30 | — |
| Unsaturated | SA9000 | 70 | 100 | — | — | 70 | 70 |
| carbon-carbon | OPE-2st 1200 | — | — | — | — | — | — |
| double bond- | OPE-2st 2200 | — | — | — | — | — | — |
| containing | | | | | | | |
| polyphenylene | | | | | | | |
| ether resin | | | | | | | |
| Maleimide | BMI-5100 | — | — | — | — | — | — |
| resin | BMI-2300 | — | — | — | — | — | — |
| | Formula (3) | 30 | — | 100 | — | 30 | 30 |
| | Formula (4) | — | — | — | 100 | — | — |
| | Formula (5) | — | — | — | — | — | — |
| Polyolefin | B-3000 | — | — | — | — | — | — |
| | Ricon 100 | — | — | — | — | — | — |
| | H1041 | — | — | — | — | — | — |
| | Ricon 184MA6 | — | — | — | — | — | — |
| | Divinylbenzene-styrene- | — | — | — | — | — | — |
| | ethylstyrene copolymer | | | | | | |
| Phosphorus- | Hexa(4-vinylphe- | — | — | — | — | — | — |
| containing | noxy)cyclotriphosphazene | | | | | | |
| monomer | Allyldiphenylphosphine | — | — | — | — | — | — |
| different from | Triphenylphosphine | — | — | — | — | — | — |
| Formula (1) | Diethyl 4- | — | — | — | — | — | — |
| | vinylbenzylphosphonate | | | | | | |
| | Tri(4-vinylben- | — | — | — | — | — | — |
| | zene)phosphine sulfide | | | | | | |
| Curing | 25B | 0.8 | 0.8 | 0.8 | 0.8 | 0.8 | 0.8 |
| accelerator | | | | | | | |
| Inorganic | chemically synthesized | 120 | 120 | 120 | 120 | 120 | 120 |
| filler | spherical silicon dioxide | | | | | | |
| Solvent | toluene:MEK = 1:1 | PA | PA | PA | PA | PA | PA |
| Properties | Units | E1 | E2 | E3 | E4 | E5 | E6 |
| Inner resin | / | B | B | B | B | B | A |
| flow | | | | | | | |
| Stripe | mm | 5.7 | 2.5 | 2.3 | 5.2 | 0.0 | 0.0 |
| Total burning | s | 27 | 50 | 48 | 26 | 48 | 40 |
| time | | | | | | | |
| Df | / | 0.00185 | 0.00184 | 0.00186 | 0.00195 | 0.00186 | 0.00186 |
| P/S | lb/in | 3.8 | 4.0 | 3.8 | 3.6 | 3.8 | 3.8 |
| Z-PTE | % | 1.8 | 1.8 | 1.5 | 1.6 | 1.5 | 1.5 |

TABLE 2
The components (in parts by weight) and the property testing
results of the resin composition of Examples E7 to E12

| Components | | E7 | E8 | E9 | E10 | E11 | E12 |
|---|---|---|---|---|---|---|---|
| Phosphorus- | Formula (1-3) | — | — | 25 | 20 | 15 | 10 |
| containing | Formula (1-4) | — | — | — | — | — | — |
| monomer | Formula (1-5) | — | — | — | — | — | — |
| represented by | Formula (1-6) | — | — | — | — | — | — |
| Formula (1) | Formula (1-7) | — | — | — | — | — | — |
| | Formula (1-1) | 65 | 10 | — | — | — | — |
| | Formula (1-2) | — | — | 5 | 10 | 15 | 20 |
| Unsaturated | SA9000 | 70 | 70 | 70 | 70 | 70 | 70 |
| carbon-carbon | OPE-2st 1200 | — | — | — | — | — | — |
| double bond- | OPE-2st 2200 | — | — | — | — | — | — |
| containing | | | | | | | |
| polyphenylene | | | | | | | |
| ether resin | | | | | | | |
| Maleimide | BMI-5100 | — | — | — | — | — | — |
| resin | BMI-2300 | — | — | — | — | — | — |
| | Formula (3) | 30 | 30 | 30 | 30 | 30 | 30 |
| | Formula (4) | — | — | — | — | — | — |
| | Formula (5) | — | — | — | — | — | — |
| Polyolefin | B-3000 | — | — | — | — | — | — |
| | Ricon 100 | — | — | — | — | — | — |
| | H1041 | — | — | — | — | — | — |
| | Ricon 184MA6 | — | — | — | — | — | — |
| | Divinylbenzene-styrene- | — | — | — | — | — | — |
| | ethylstyrene copolymer | | | | | | |
| Phosphorus- | Hexa(4-vinylphe- | — | — | — | — | — | — |
| containing | noxy)cyclotriphosphazene | | | | | | |
| monomer | Allyldiphenylphosphine | — | — | — | — | — | — |
| different from | Triphenylphosphine | — | — | — | — | — | — |
| Formula (1) | Diethyl 4- | — | — | — | — | — | — |
| | vinylbenzylphosphonate | | | | | | |
| | Tri(4-vinylben- | — | — | — | — | — | — |
| | zene)phosphine sulfide | | | | | | |
| Curing | 25B | 0.8 | 0.8 | 0.8 | 0.8 | 0.8 | 0.8 |
| accelerator | | | | | | | |
| Inorganic filler | chemically synthesized | 120 | 120 | 120 | 120 | 120 | 120 |
| | spherical silicon dioxide | | | | | | |
| Solvent | toluene:MEK = 1:1 | PA | PA | PA | PA | PA | PA |
| Properties | Units | E7 | E8 | E9 | E10 | E11 | E12 |
| Inner resin | / | A | A | A | A | A | A |
| flow | | | | | | | |
| Stripe | mm | 0.0 | 0.0 | 0.0 | 0.0 | 0.0 | 0.0 |
| Total burning | s | 31 | 50 | 30 | 33 | 37 | 40 |
| time | | | | | | | |
| Df | / | 0.00185 | 0.00187 | 0.00186 | 0.00187 | 0.00188 | 0.00189 |
| P/S | lb/in | 3.6 | 4.0 | 3.8 | 3.8 | 3.9 | 3.8 |
| Z-PTE | % | 1.4 | 1.6 | 1.7 | 1.7 | 1.6 | 1.6 |

TABLE 3
The components (in parts by weight) and the property testing
results of the resin composition of Examples E13 to E18

| Components | | E13 | E14 | E15 | E16 | E17 | E18 |
|---|---|---|---|---|---|---|---|
| Phosphorus- | Formula (1-3) | — | — | — | — | 5 | 5 |
| containing | Formula (1-4) | 25 | — | — | 10 | — | 5 |
| monomer | Formula (1-5) | — | 35 | — | — | 5 | 5 |
| represented by | Formula (1-6) | — | — | — | 5 | — | 5 |
| Formula (1) | Formula (1-7) | — | — | 15 | — | 5 | 5 |
| | Formula (1-1) | 10 | 15 | 25 | 10 | 10 | 5 |
| | Formula (1-2) | — | — | — | 15 | 15 | 10 |
| Unsaturated | SA9000 | — | — | — | 60 | 50 | 55 |
| carbon-carbon | OPE-2st 1200 | — | 100 | — | 12 | 5 | 10 |
| double bond- | OPE-2st 2200 | — | — | 100 | 12 | 5 | 10 |
| containing | | | | | | | |
| polyphenylene | | | | | | | |
| ether resin | | | | | | | |
| Maleimide | BMI-5100 | — | — | — | 8 | 24 | 8 |
| resin | BMI-2300 | — | — | — | — | 1 | 2 |
| | Formula (3) | — | — | — | 8 | 10 | 5 |
| | Formula (4) | — | — | — | — | 5 | — |
| | Formula (5) | 100 | — | — | — | — | 10 |
| Polyolefin | B-3000 | — | — | — | 5 | 5 | 5 |
| | Ricon 100 | — | — | — | 9 | — | — |
| | H1041 | — | 25 | 15 | 10 | 10 | 5 |
| | Ricon 184MA6 | — | — | — | — | 2 | — |
| | Divinylbenzene-styrene- | — | — | — | 22 | 8 | 5 |
| | ethylstyrene copolymer | | | | | | |
| Phosphorus- | Hexa(4-vinylphe- | — | — | — | — | — | 15 |
| containing | noxy)cyclotriphosphazene | | | | | | |
| monomer | Allyldiphenylphosphine | — | — | — | — | — | — |
| different from | Triphenylphosphine | — | — | — | — | — | — |
| Formula (1) | Diethyl 4- | — | — | — | — | — | — |
| | vinylbenzylphosphonate | | | | | | |
| | Tri(4-vinylben- | — | — | — | — | — | — |
| | zene)phosphine sulfide | | | | | | |
| Curing | 25B | 0.8 | 0.8 | 0.8 | 0.8 | 0.1 | 3.0 |
| accelerator | | | | | | | |
| Inorganic filler | Chemically synthesized | 120 | 120 | 120 | 120 | 80 | 300 |
| | spherical silicon dioxide | | | | | | |
| Solvent | toluene:MEK = 1:1 | PA | PA | PA | PA | PA | PA |
| Properties | Units | E13 | E14 | E15 | E16 | E17 | E18 |
| Inner resin | / | A | A | A | A | A | A |
| flow | | | | | | | |
| Stripe | mm | 0.0 | 0.0 | 0.0 | 0.0 | 0.0 | 0.0 |
| Total burning | s | 31 | 43 | 38 | 38 | 40 | 30 |
| time | | | | | | | |
| Df | / | 0.00183 | 0.00192 | 0.00190 | 0.00176 | 0.00179 | 0.00175 |
| P/S | lb/in | 3.7 | 3.6 | 3.7 | 3.8 | 3.7 | 3.7 |
| Z-PTE | % | 1.6 | 1.2 | 1.4 | 1.6 | 1.6 | 1.3 |

TABLE 4
The components (in parts by weight) and the property testing results
of the resin composition of Comparative Examples C1 to C7

| Components | | C1 | C2 | C3 | C4 | C5 | C6 | C7 |
|---|---|---|---|---|---|---|---|---|
| Phosphorus- | Formula (1-3) | — | — | — | — | — | — | — |
| containing | Formula (1-4) | — | — | — | — | — | — | — |
| monomer | Formula (1-5) | — | — | — | — | — | — | — |
| represented by | Formula (1-6) | — | — | — | — | — | — | — |
| Formula (1) | Formula (1-7) | — | — | — | — | — | — | — |
| | Formula (1-1) | 0 | 75 | — | — | — | — | — |
| | Formula (1-2) | — | — | — | — | — | — | — |
| Unsaturated | SA9000 | 70 | 70 | 70 | 70 | 70 | 70 | 70 |
| carbon-carbon | OPE-2st 1200 | — | — | — | — | — | — | — |
| double bond- | OPE-2st 2200 | — | — | — | — | — | — | — |
| containing | | | | | | | | |
| polyphenylene | | | | | | | | |
| ether resin | | | | | | | | |
| Maleimide | BMI-5100 | — | — | — | — | — | — | — |
| resin | BMI-2300 | — | — | — | — | — | — | — |
| | Formula (3) | 30 | 30 | 30 | 30 | 30 | 30 | 30 |
| | Formula (4) | — | — | — | — | — | — | — |
| | Formula (5) | — | — | — | — | — | — | — |
| Polyolefin | B-3000 | — | — | — | — | — | — | — |
| | Ricon 100 | — | — | — | — | — | — | — |
| | H1041 | — | — | — | — | — | — | — |
| | Ricon 184MA6 | — | — | — | — | — | — | — |
| | Divinylbenzene- | — | — | — | — | — | — | — |
| | styrene-ethylstyrene | | | | | | | |
| | copolymer | | | | | | | |
| Phosphorus-free cross- | | — | — | 30 | — | — | — | — |
| linking monomer | | | | | | | | |
| Phosphorus- | Hexa(4-vinylphe- | — | — | — | — | — | — | |
| containing | noxy)cyclotriphosphazene | | | | | | | |
| monomer | Allyldiphenylphosphine | — | — | — | 30 | — | — | — |
| different from | Triphenylphosphine | — | — | — | — | 30 | — | — |
| Formula (1) | Diethyl 4- | — | — | — | — | — | 30 | — |
| | vinylbenzylphosphonate | | | | | | | |
| | Tri(4-vinylben- | — | — | — | — | — | — | 30 |
| | zene)phosphine sulfide | | | | | | | |
| Curing | 25B | 0.8 | 0.8 | 0.8 | 0.8 | 0.8 | 0.8 | 0.8 |
| accelerator | | | | | | | | |
| Inorganic filler | chemically | 120 | 120 | 120 | 120 | 120 | 120 | 120 |
| | synthesized spherical | | | | | | | |
| | silicon dioxide | | | | | | | |
| Solvent | toluene:MEK = 1:1 | PA | PA | PA | PA | PA | PA | PA |
| Properties | Units | C1 | C2 | C3 | C4 | C5 | C6 | C7 |
| Inner resin | / | C | C | B | C | C | C | C |
| flow | | | | | | | | |
| Stripe | mm | 0.0 | 0.0 | 0.0 | 6.2 | 0.0 | 7.5 | 0.0 |
| Total burning | s | 95 | 25 | 97 | 55 | 28 | 55 | 55 |
| time | | | | | | | | |
| Df | / | 0.00189 | 0.00184 | 0.00185 | 0.00195 | 0.00190 | 0.00211 | 0.00219 |
| P/S | lb/in | 1.5 | 3.0 | 3.4 | 3.3 | 3.4 | 3.3 | 3.4 |
| Z-PTE | % | 1.8 | 1.5 | 1.8 | 2.0 | 2.2 | 2.0 | 1.6 |

The property tests of the Examples and Comparative Examples of the present disclosure are performed by preparing test specimens (samples) in the following manner and then performing the tests under specific test conditions.
(1) Prepreg (PP): The insulating resin compositions from each Examples or each Comparative Examples are used, and the components thereof are well-mixed to form a varnish. The varnish is loaded into an impregnation tank, and a fiberglass fabric (e.g., 2116 or 1080 L-glass fiber fabric, available from Asahi) is immersed into the impregnation tank to adhere the insulating resin composition onto the fiberglass fabric, followed by heated at 150° C. to 170° C. to a semi-cured state (B-stage), thereby obtaining a prepreg. The resin content of the prepreg made of 1080 L-glass fiber fabric is about 70%; the resin content of the prepreg made of 2116 L-glass fiber fabric is about 55%.
(2) Copper-clad laminate (8-ply, formed by laminating 8 prepregs): Two hyper very low profile (HVLP) copper foils with a thickness of 18 μm and eight prepregs obtained from 2116 L-glass fiber fabrics impregnated with samples of each of Examples and Comparative Examples and each having a resin content of about 55% are prepared. They are stacked in an order of one copper foil, eight prepregs and one copper foil, followed by lamination under vacuum at 420 psi and 200° C. for 2 hours to form Copper-clad laminate (8-ply).
(3) Copper-clad laminate (2-ply, formed by laminating 2 prepregs): Two hyper very low profile (HVLP) copper foils with a thickness of 18 μm and two prepregs obtained from 1080 L-glass fiber fabrics impregnated with samples of each of Examples and Comparative Examples are prepared. They are stacked in an order of one copper foil, two prepregs and one copper foil, followed by lamination under vacuum at 420 psi and 200° C. for 2 hours to form Copper-clad laminate (2-ply).
(4) Copper-free four-layered laminate (formed by laminating two prepregs and one core board): A prepreg obtained from 1080 L-glass fiber fabrics impregnated with samples of each of Examples and Comparative Examples are prepared. Two reverse treat foils (RTF copper foils) are stacked on both sides of the prepreg, respectively, followed by lamination under vacuum at 420 psi and 200° C. for 2 hours to form a copper-clad core board. They are stacked in an order of one copper foil, one prepreg, one copper-clad core board, one prepreg and one copper foil, followed by lamination under vacuum at 420 psi and 200° C. for 2 hours to form copper-clad four-layered laminate. The copper-clad four-layered laminate is etched to remove the two outmost copper foils to obtain a copper-free four-layered laminate.
(5) Copper-free laminate (8-ply, formed by laminating 8 prepregs): Each Copper-clad laminate (8-ply) is etched to remove the copper foils on both sides to obtain a copper-free laminate (8-ply).
(6) Copper-free laminate (2-ply, formed by laminating 2 prepregs): Each Copper-clad laminate (2-ply)x is etched to remove the copper foils on both sides to obtain a copper-free laminate (2-ply).

### 1. Inner Resin Flow

First, an EM-827 copper-clad laminate is selected as a copper-clad core (available from Elite Electronic Material (Kunshan) Co., Ltd., using 7628 E-glass fiber fabric and 1-ounce HTE copper foil), which has a thickness of 28 mil. Then, the outmost copper foil of the copper-clad core is subjected to a conventional brown oxidation process to obtain a brown oxide-treated core.

Then, each Prepreg prepared from each Example and each Comparative Example are prepared, and are cut into four 4 inches*4 inches rhombus prepregs by using a conventional punching machine. One brown oxide-treated core, one rhombus prepreg, and one 0.5-ounce HTE copper foil (in reverse position, i.e., the glossy surface (shiny side) of the copper foil is in contact with the rhombus prepreg) are stacked in such order, followed by lamination and curing for 2 hours under vacuum at high temperature (200° C.) and high pressure (420 psi), and then the HTE copper foil is removed to obtain a sample for an inner resin flow test. Each side of the 4 inches*4 inches rhombus shape of the sample for the inner resin flow test is divided into four equal sections by three dividing points, and the resin flow (i.e., vertical distance of resin flow at each dividing points) of each of the twelve points is measured to obtain the average of resin flow at the twelve points, so as to obtain the inner resin flow (as an average, in mm).

The inner resin flow is classified into three level, such as level A, level B, and level C, where level A is the best, level B is the second best, and level C is the worst.
Level A: inner resin flow=4 to 7.5 mm,
Level B: 3 mm≤inner resin flow<4 mm or 7.5 mm<inner resin flow≤12 mm,
Level C: inner resin flow<3 mm or >12 mm.

Generally, the inner resin flow is preferably between 4 and 7.5 mm. Excessive inner resin flow (e.g., inner resin flow>12 mm) may easily causes a thinner laminate and uneven thickness at different positions. On the other hand, insufficient inner resin flow (e.g., resin flow<3 mm) may causes surface defects such as a dry board of laminate and other surface irregularities.

### 2. Stripe at Edge

The copper-free four-layered laminate is visually inspected whether there are stripe patterns (referred to as “stripes”) at the board edge. A schematic diagram of board edge stripes can be found in FIG. 6 of US Patent Application Publication No. 10,889,672 B2, while a schematic diagram of board edges without stripes can be found in FIG. 8 of the same patent. The length of the stripes is measured in millimeters (mm). Shorter lengths are preferable. A length of 0 mm is the best, a length greater than 0 mm but less than or equal to 6 mm is second best, and a length greater than 6 mm is the worst.

### 3. Total Burning Time

Copper-free laminates (8-ply) above are selected as samples, and five samples are selected as a group for each Example and Comparative Example. Two self-extinguishing time after two ignitions of each sample are measured by reference to UL94. The sum of the two self-extinguishing time of each sample is recorded as an individual burning time, and the sum of the individual burning times of five samples is recorded as total burning time, in second.

If the individual burning time≤10 seconds, the total burning time≤50 seconds, and there is no molten dripping during the burning process of the group of samples and the flame does not spread to the fixture, the UL94 flame resistance level of this group of samples is recorded as V0;
If the individual burning time≤30 seconds, the total burning time≤250 seconds, and there is no molten dripping during the burning process of the group of samples and the flame does not spread to the fixture, the UL94 flame resistance level of this group of samples is recorded as V1;
If the individual burning time≤30 seconds, the total burning time≤250 seconds, and there is molten dripping during the burning process of the group of samples and the flame does not spread to the fixture, the UL94 flame resistance level of this group of samples is recorded as V2;
Flame resistance of Level V0 is better than flame resistance of Level V1, and flame resistance of Level V1 is better than flame resistance of Level V2.

### 4. Dissipation Factor (Df)

Copper-free laminates (2-ply) above are selected as samples. The dissipation factors of the samples are measured at room temperature (about 25° C.) and a frequency of 10 GHz by a microwave dielectrometer (available from AET, Inc.) by reference to JIS C2565. A lower dissipation factor indicates a better dielectric properties of the sample.

### 5. Peel Strength (P/S)

Copper-clad laminates (8-ply) above are cut into rectangular samples with a width of 24 mm and a length greater than 60 mm, and the samples are etched to remove the surface copper foil, and only a strip copper foil with a width of 3.18 mm and a length of greater than 60 mm is remained. The samples are measured for the force required to peel the copper foil away from the surface of the laminate insulation layer at room temperature (about 25° C.) by a universal tensile tester by reference to IPC-TM-650 2.4.8, in lb/in.

### 6. Z-Axis Percent of Thermal Expansion (Z-PTE)

Copper-free laminates (8-ply) are selected as samples, and heated at a rate of 10° C. per minute from 50° C. to 260° C. Each sample is measured for Z-axis percent of thermal expansion (in %) in a temperature range of 50° C. to 260° C. by thermal mechanical analysis (TMA) by reference to IPC-TM-650 2.4.24.5.

By referring to the property testing results in Table 1 to Table 4, the following phenomena can be clearly observed:

From Examples E1 to E18, it can be found that the article made from the insulating resin composition of the present disclosure can have improvements in the properties, including inner resin flow, stripe, flame resistance, dissipation factor, peel strength and Z-axis percent of thermal expansion, thereby obtaining a suitable inner resin flow, higher flame resistance and peel strength, a shorter stipe, lower dissipation factor and Z-axis percent of thermal expansion.

Among them, Examples E1 to E5 use “the phosphorus-containing monomer represented by Formula (1) with one C2 to C4 alkenyl group” alone (E1 to E4 use the phosphorus-containing monomer represented by Formula (1-3) to Formula (1-6) alone, respectively.) or use “the phosphorus-containing monomer represented by Formula (1) with at least three C2 to C4 alkenyl group” alone (E5 uses the phosphorus-containing monomer represented by Formula (1-2) alone.). Examples E6 to E18 do not use “the phosphorus-containing monomer represented by Formula (1) with one C2 to C4 alkenyl group” alone and do not use “the phosphorus-containing monomer represented by Formula (1) with at least three C2 to C4 alkenyl group” alone, such as using “the phosphorus-containing monomer represented by Formula (1) with two C2 to C4 alkenyl group” alone (E6 to E8), or using “the phosphorus-containing monomer represented by Formula (1) with one C2 to C4 alkenyl group” and “the phosphorus-containing monomer represented by Formula (1) with at least three C2 to C4 alkenyl group” in combination (E9 to E12), or using “the phosphorus-containing monomer represented by Formula (1) with one C2 to C4 alkenyl group” and “the phosphorus-containing monomer represented by Formula (1) with two C2 to C4 alkenyl group” in combination (E13 to E15), or using “the phosphorus-containing monomer represented by Formula (1) with one C2 to C4 alkenyl group,” “the phosphorus-containing monomer represented by Formula (1) with two C2 to C4 alkenyl group” and “the phosphorus-containing monomer represented by Formula (1) with at least three C2 to C4 alkenyl group” in combination (E16 to E18). According to the comparison of Examples E1 to E5 and Examples E6 to E18, it can be found that if the insulating resin composition of the present disclosure and the article made therefrom do not use “the phosphorus-containing monomer represented by Formula (1) with one C2 to C4 alkenyl group” alone and do not use “the phosphorus-containing monomer represented by Formula (1) with at least three C2 to C4 alkenyl group” alone, they can have significant improvement in at least one property including inner resin flow.

According to the comparison of Examples E1 to E18 and Comparative Examples C1 to C2, it can be found that if with respect to 100 parts by weight of the unsaturated carbon-carbon double bond-containing polyphenylene ether resin and/or the maleimide resin, the amount of the phosphorus-containing monomer represented by Formula (1) is beyond the range of 10 to 65 parts by weight, there are significant deteriorations in at least two properties including inner resin flow and peel strength.

According to the comparison of Examples E1 to E18 and Comparative Example C3, it can be found that if the phosphorus-containing monomer represented by Formula (1) is replaced with a phosphorus-free crosslinking monomer, there are significant deteriorations in at least two properties including flame resistance and peel strength.

According to the comparison of Examples E1 to E18 and Comparative Examples C4 to C7, it can be found that if the phosphorus-containing monomer represented by Formula (1) is replaced with a phosphorus-containing monomer different from Formula (1) in C4 to C7, there are significant deteriorations in at least two properties including inner resin flow and peel strength.

What is claimed is:

1. An insulating resin composition, wherein the insulating resin composition comprises:
(A): 100 parts by weight of an unsaturated carbon-carbon double bond-containing polyphenylene ether resin and/or a maleimide resin, and
(B): 10 to 65 parts by weight of a phosphorus-containing monomer represented by Formula (1), 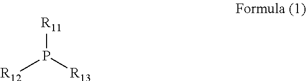
wherein in Formula (1), Ru is a C2 to C4 alkenyl group-substituted phenyl group, and each of R₁₂ and R₁₃ is independently a C1 to C4 alkyl group, a C2 to C4 alkenyl group, a phenyl group, a C1 to C4 alkyl group-substituted phenyl group, a C2 to C4 alkenyl group-substituted phenyl group, a biphenyl group or a naphthyl group.

2. The insulating resin composition of claim 1, wherein the phosphorus-containing monomer represented by Formula (1) comprises one or more of compounds represented by Formula (1-1) to Formula (1-10),

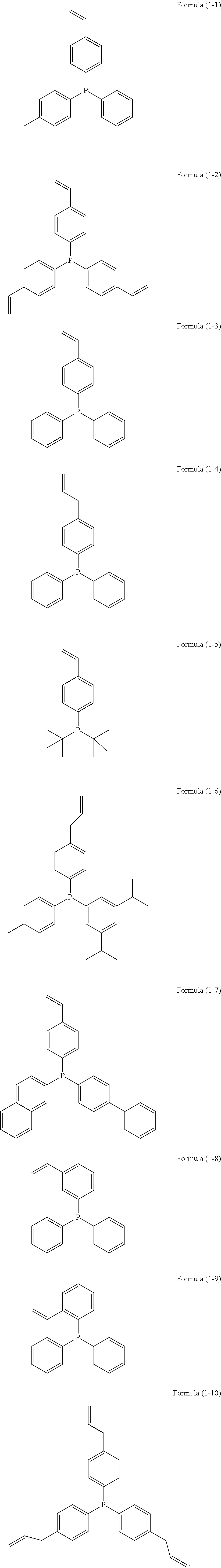

3. The insulating resin composition of claim 1, wherein the insulating resin composition does not comprise the phosphorus-containing monomer represented by Formula (1) with one C2 to C4 alkenyl group alone, and does not comprise the phosphorus-containing monomers represented by Formula (1) with at least three C2 to C4 alkenyl group alone.

4. The insulating resin composition of claim 1, wherein the unsaturated carbon-carbon double bond-containing polyphenylene ether resin comprises any one of a vinylbenzyl group-containing polyphenylene ether resin, a (meth)acryloyl group-containing polyphenylene ether resin, a vinyl group-containing polyphenylene ether resin, a allyl group-containing polyphenylene ether resin or a combination thereof.

5. The insulating resin composition of claim 1, wherein the maleimide resin comprises any one of a 4,4′-diphenylmethane bismaleimide, a polyphenylmethane maleimide, a bisphenol A diphenyl ether bismaleimide, a 3,3′-dimethyl-5,5′-diethyl-4,4′-diphenylmethane bismaleimide, a 3,3′-dimethyl-5,5′-dipropyl-4,4′-diphenylmethane bismaleimide, a m-phenylene bismaleimide, a 4-methyl-1,3-phenylene bismaleimide, a 1,6-bismaleimide-(2,2,4-trimethyl)hexane, an N-2,3-xylylmaleimide, an N-2,6-xylylmaleimide, an N-phenylmaleimide, a vinyl benzyl maleimide, an indane structure-containing maleimide, an isopropyl and meta-arylene structure-containing maleimide, a biphenyl structure-containing maleimide, a maleimide with aliphatic structure having 10 to 50 carbon atoms or a combination thereof.

6. The insulating resin composition of claim 1, wherein the insulating resin composition further comprises any one of a polyolefin, a benzoxazine resin, an epoxy resin, a polyester resin, a phenolic resin, an amine curing agent, a polyamide, a polyimide, a styrene maleic anhydride, a cyanate ester resin, a maleimide triazine resin or a combination thereof.

7. The insulating resin composition of claim 1, wherein the insulating resin composition further comprises any one of a flame retardant different from the phosphorus-containing monomer represented by Formula (1), a curing accelerator, a polymerization inhibitor, an inorganic filler, a solvent, a silane coupling agent, a surfactant, a coloring agent, a toughening agent or a combination thereof.

8. The insulating resin composition of claim 7, wherein the flame retardant different from the phosphorus-containing monomer represented by Formula (1) comprises a vinyl phosphazene compound, and a mass ratio between the phosphorus-containing monomer represented by Formula (1) to the vinyl phosphazene compound is 1:10 to 10:1.

9. An article made from the insulating resin composition of claim 1, wherein the article comprises a prepreg, a resin film, a metal foil-clad laminate or a printed circuit board.

10. The article of claim 9, having a total burning time as measured by reference to UL94 of less than or equal to 50 seconds.

11. The article of claim 9, having a dissipation factor as measured by reference to JIS C2565 of less than or equal to 0.00195.

12. The article of claim 9, having a peel strength as measured by reference to IPC-TM-650 2.4.8 of greater than or equal to 3.6 lb/in.

13. The article of claim 9, having a Z-axis percent of thermal expansion as measured by reference to IPC-TM-650 2.4.24.5 of less than or equal to 1.8%.
